(19) United States
(12) Patent Application Publication
(10) Pub. No.: US 2014/0095358 A1
(43) Pub. Date: Apr. 3, 2014

(54) METHODS AND SYSTEMS FOR DISPLAYING TIME-SENSITIVE AVAILABILITY AND PROMOTIONS FOR PRODUCTS

(71) Applicant: United Video Properties, Inc., Santa Clara, CA (US)

(72) Inventors: Sivakumar Chandrasekharan, Pleasanton, CA (US); James Roth, Novato, CA (US); Michael Nichols, La Canada, CA (US); Walter Klappert, Los Angeles, CA (US)

(73) Assignee: UNITED VIDEO PROPERTIES, INC., Santa Clara, CA (US)

(21) Appl. No.: 13/630,955

(22) Filed: Sep. 28, 2012

(51) Int. Cl. G06Q 30/06

(52) U.S. Cl. CPC G06Q 30/0643
USPC 705/27.2

(57) ABSTRACT

Methods and systems are described herein for providing a storefront administration application which provides improved design and review capabilities for the makers of virtual storefronts. The storefront administration application receives, stores, and processes information associated with virtual storefronts and product listings to allow sellers the ability to inspect and modify the appearance of their virtual storefronts at a past, current, and/or future date based on the products that are, or will be, available.

### BACKGROUND OF THE INVENTION

Virtual storefronts are websites that provide customers with the ability to purchase goods or services. Generally, virtual storefronts present customers with a number of product listings, each of which indicates the product being sold and its price. A virtual storefront may include a number of webpages, including a main page (i.e., a “homepage”), category pages (e.g., for different types of products), a search page, a shopping cart page, and a checkout page. The home page of a virtual storefront may, for example, present product listings for products that are currently popular or newly available.

As product availability continuously changes, virtual storefronts must be constantly updated. As such, sellers must routinely update which products are displayed to customers, i.e., to remove unavailable products, to add newly available products, and/or to highlight products soon to become unavailable. Furthermore, as the virtual storefront may represent the only means by which a seller may advertise and offer for sale its products to a customer, the placement of each product is essential to profitability. Therefore, which products are listed on a webpage, in addition to where each product is listed, is of upmost importance to the seller. A poorly designed or outdated virtual storefront may result in low sales and decreased profits for the seller.

### SUMMARY OF THE DISCLOSURE

Accordingly, methods and systems are described herein for a storefront administration application which provides improved design and review capabilities for the makers of virtual storefronts. Specifically, the storefront administration application gives sellers the ability to inspect and modify the appearance of their virtual storefronts as the storefront will appear at a future date based on the products that are, or will be, available. For example, for products that have particular release dates (e.g., DVD's of particular movies), the storefront administration application may assist sellers in determining what products may appear (e.g., are available to purchase) on their websites on a particular date. The ability to view and organize the products ahead of time allows sellers ample opportunity to determine the most efficient (and profitable) arrangements for their products.

For example, in order for a seller to preview their virtual storefronts, the seller needs only to input the date he or she wishes to preview. In response, the storefront administration application processes data associated with the products currently offered, or that will be offered, on the seller's virtual storefront to generate a preview webpage. The generated webpage displays the virtual storefront as it would appear to a potential customer on the requested date. The seller can then view the products that are available for purchase on that date and input adjustments to the storefront administration application.

In addition, the storefront administration application may organize and present additional information about each of the products in an efficient manner to assist the sellers in determining which particular products should appear on their websites at any particular date. For example, a seller may access a screen of media assets that are to be released on a future date. The seller may then select, via a user input, each media asset. In response, the storefront administration application returns an overlay displaying box office ticket sales, critical reviews, or other information, which may assist the seller in determining whether or not customers will likely be interested in the media asset. If the information indicates that customers are more likely to be interested in the media asset, the seller may input instructions to feature the media asset more prominently on the webpage.

In order for the storefront administration application to provide the aforementioned capabilities, the storefront administration application may receive, store, and process information regarding both virtual storefronts and product listings. In some embodiments, data may be received via user inputs, default settings, and/or instructions transmitted from remote devices. Using the control circuitry of the device on which the storefront administration application is implemented, the storefront administration application may identify a particular virtual storefront associated with a particular seller, including the layout of the webpage (e.g., the number, size, and positioning of different promotional regions) as well as determine the product listings associated with each virtual storefront and the status (e.g., available, available soon, or not available) of the product listings on any particular date. The storefront administration application may further receive indications of different dates on which to generate a webpage allowing a seller to view and/or arrange the appearance of the product listings in a webpage corresponding to each date.

For example, the storefront administration application may store, on either a local or remote database, numerous product listings, in which each product listing is associated with a storefront identifier and a date range specifying its availability for purchase. Upon receiving an indication of a requested storefront identifier and a requested date, the storefront administration application instructs the control circuitry of the device upon which it is implemented to retrieve layout information, which instructs the storefront administration application on where to display the various promotional regions for the storefront corresponding to the requested storefront identifier. The storefront administration application then searches the product listings to identify product listings that are both associated with the requested storefront identifier and include a date range that encompasses the requested date. The storefront administration application then generates a webpage using the retrieved layout information that includes the identified product listings in the appropriate promotional regions.

In some embodiments, the storefront administration application may allow the seller to input instructions to sort, edit, add, and/or remove product listings and/or promotional regions that appear in any webpage on any given date. Furthermore, the storefront administration application may generate webpages with promotional regions that include product listings according to particular inputted criteria, or may include various resource palettes, which allow a seller to further customize a webpage on any given date or view product listings according to any particular status.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1A is a block diagram of an illustrative user equipment device in accordance with some embodiments of the disclosure;

FIG. 1B is a block diagram of an illustrative media system in accordance with some embodiments of the disclosure;

FIG. 2 shows a conceptual illustration of virtual storefront look-ahead and look-back capability in accordance with some embodiments of the disclosure;

FIG. 3 shows an illustrative display screen of a storefront administration application used to generate a webpage featuring look-ahead and look-back capabilities for a virtual storefront in accordance with some embodiments of the disclosure;

FIG. 4 shows an illustrative display screen of a storefront administration application used to generate a webpage featuring look-ahead and look-back capabilities for a virtual storefront, including a resource palette used to view the availability status of product listings on a first date in accordance with some embodiments of the disclosure;

FIG. 5 shows an illustrative display of the storefront administration application used to generate a webpage featuring look-ahead and look-back capabilities for a virtual storefront, including a resource palette used to view the availability status of product listings on a second date in accordance with some embodiments of the disclosure;

FIG. 6 shows an illustrative display of the storefront administration application used to generate a webpage featuring look-ahead and look-back capabilities for a virtual storefront, including multiple resource palettes used to view the availability status of product listings on a first date in accordance with some embodiments of the disclosure;

FIG. 7 shows an illustrative display of the storefront administration application used to view additional information of product listings that may appear in promotional regions of a webpage generated by the storefront administration application in accordance with some embodiments of the disclosure;

FIG. 8A is an illustrative data structure of data that accompanies a storefront identifier in accordance with some embodiments of the disclosure;

FIG. 8B is an illustrative data structure of data associated with a product listing in accordance with some embodiments of the disclosure; and

FIG. 9 is a flowchart of illustrative steps for generating a webpage for a particular date featuring product listings identified as available on that date in accordance with some embodiments of the disclosure.

### DETAILED DESCRIPTION OF DRAWINGS

Methods and systems are described herein for providing a storefront administration application which provides improved design and review capabilities for the makers of virtual storefronts. Specifically, the storefront administration application gives sellers the ability to inspect and modify the appearance of their virtual storefronts at a past, current, and/or future date based on the products that are, or will be, available. For example, for products that have particular release dates (e.g., DVD's of particular movies), the storefront administration application may assist sellers in determining what (and where) products will appear on their websites on a particular date. The ability to view and organize the products ahead of time allows sellers ample opportunity to determine the most efficient (and profitable) arrangements for their products.

As used herein, a “seller” or “user” of the storefront administration application is a person and/or entity that uses the storefront administration application to perform functions related to the administration of the virtual storefront. For example, a user, whether the virtual storefront owner and/or web-designer employed by the storefront owner, may use the storefront administration application to view and/or adjust product listings that appear, have appeared, or may appear on the virtual storefront. As used herein, a “customer” is a person and/or entity that uses the virtual storefront produced using the storefront administration application to view, gain information and/or purchase products listed on the virtual storefront.

As product availability regularly changes, virtual storefronts must be updated accordingly. Sellers therefore maintain their virtual storefronts by constantly updating which products are displayed to users, i.e., to remove unavailable products, to add newly available products, and/or to highlight products soon to become unavailable. The window of time during which a product is available for purchase is hereinafter referred to as a “product window.”

Product window information is especially significant in the media context. New media assets (e.g., television programs, movies, songs, etc.) are constantly becoming available, and existing media assets may be available for only a limited time. Sellers often wish to capitalize, for example, on the hype generated by a release of a popular movie on DVD, which may occur months or years after the initial theater screening. Licensing agreements between content producers and sellers adds another variable to product windows for media assets, as a given seller may only have rights to sell a particular media asset for a limited time. More generally, it is highly advantageous for sellers to know the product windows for media assets when designing their virtual storefronts so that they can add, remove, or highlight media assets in an informed and efficient manner.

In accordance with an embodiment of the present invention, sellers are provided with the capability to interactively modify their virtual storefronts while being informed of what products are available, unavailable, or will soon become available or unavailable. A seller may decide, for instance, that a certain product that is soon to be released should be promoted over other products, or that a product soon to become unavailable should be highlighted. In one approach, for example, a seller may be provided with a storefront design screen and a resource palette that contains a list of product listings for various media assets. The storefront administration application may display additional information (as described below) regarding each of the product listings.

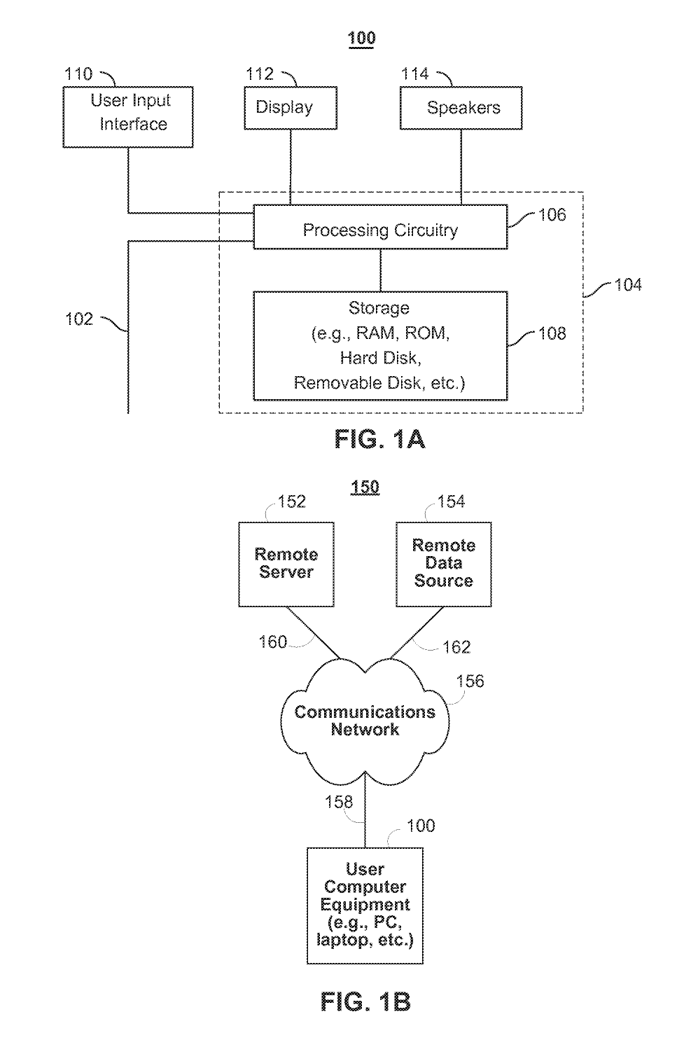

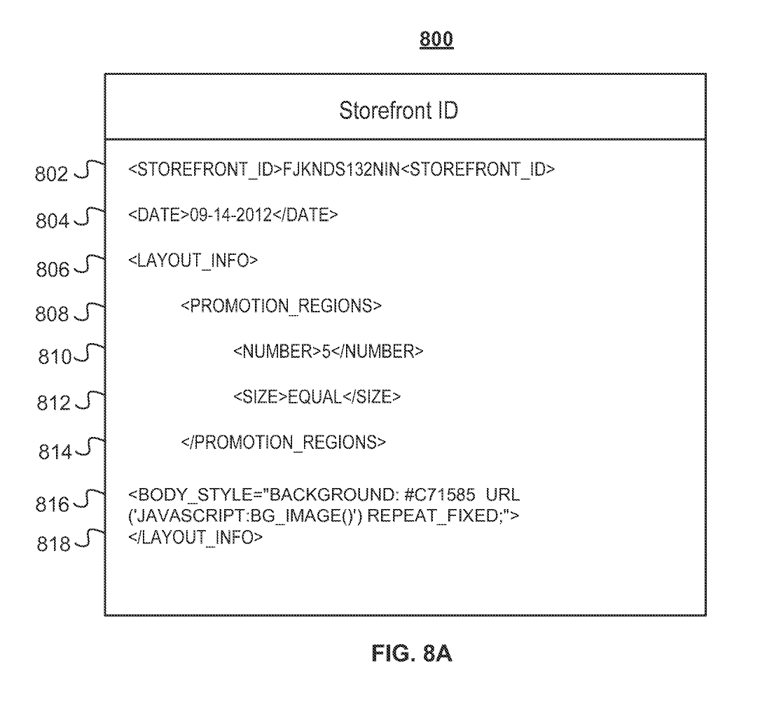

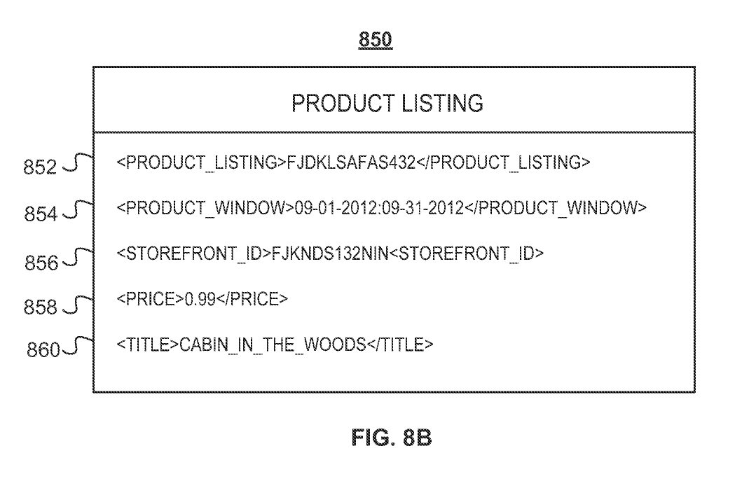

The storefront administration application may process the additional information to determine additional information that may be of interest or assistance to a user. For example, the storefront administration application may retrieve the name of a product's producer (e.g., via data structure 850 (FIG. 8B) discussed below). The storefront administration application may then compare the product's producer to the producers of other products that may appear on the same display screen at some point in the future. If competing products are displayed during the same display screen, the storefront administration application may alert the user (e.g., via display 112 (FIG. 1A)) or exclude the competing products.

As used herein, a “resource palette” is a feature of the storefront administration application that is used to sort, edit, display, or modify a virtual storefront. The resource palette may allow a user to sort or retrieve a plurality of product listings based on one or more criteria. For example, the user may use the resource palette to view products with a particular availability status. Additionally and/or alternatively, a resource palette may be used to group and/or categorize products according to any other criteria (e.g., genre, theme, etc.).

The seller may interact with the resource palette (e.g., via user input interface 110 (FIG. 1A)) to drag and drop media assets into promotional regions of the virtual storefront layout. The resource palette, or the product listings themselves, may indicate product window information for the media assets (i.e., whether the media asset is available, unavailable, soon to be available, or soon to be unavailable). In addition, the user may be provided with the capability to filter the product listings displayed in the resource palette according to the desired product window.

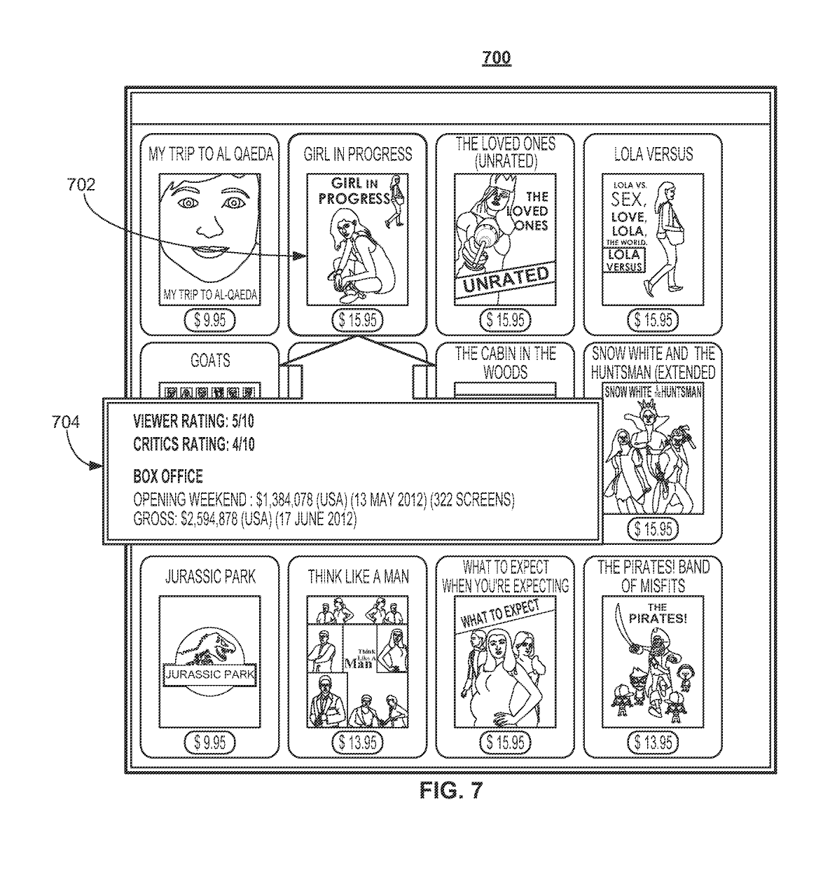

The resource palettes of the storefront administration application may include various search functions that are accessible to a user via a search tool. For example, a user (e.g., via user input interface 110 (FIG. 1A)) may sort, search, edit, add, and/or remove the product listings from virtual storefront by inputting search terms into search tools of the resource palettes accessible in the storefront administration application. As used herein, “search tools” refers to any function, application, and/or module used by the storefront administration application to view or adjust the product listings. As used herein, “search terms” refer to inputs, whether received via a user input, a default setting, and/or a remote server that defines a particular group of product listings. For example, search terms may include an availability status (e.g., available, not available, available for a particular amount of time, etc.), may include a characteristic of a product (e.g., a type medium (e.g., a DVD, BLU-RAY, On-Demand, etc.) may include a type of media (e.g., movie, game, music, etc.), may include descriptions about the content of the product (e.g., genre, plot point, character, cast and crew), or may include other designations that may define a product (e.g., related products, producer/maker of the product, use of the product, etc.). In some embodiments, resource palettes may also be used to view additional information about a product (e.g., as discussed in FIG. 7 below).

As used herein, “additional information” refers to any information used by a seller to determine whether or not a customer is more or less likely to purchase a particular product. For example, additional information may include historical information about the product (e.g., prior sales, critical reviews, user feedback, industry analyses, customer ratings, similar product comparisons, etc.). Additional information may also include availability status (e.g., available, not available, available for a particular amount of time, etc.), may include a characteristic of a product (e.g., a type medium (e.g., a DVD, BLU-RAY, On-Demand, etc.) may include a type of media (e.g., movie, game, music, etc.), may include descriptions about the content of the product (e.g., genre, plot point, character, cast and crew), or may include other designations that may define a product (e.g., related products, producer/maker of the product, use of the product, etc.).

In some embodiments, sellers are provided with the capability to redesign (e.g., via user input interface 110 (FIG. 1A)) their virtual storefronts for a date, or multiple dates, in the future. In addition, sellers may wish to design storefronts as they would appear on different user devices (e.g., mobile phones, computers, tablets, etc.) for each date. Specifically, sellers may wish to maintain several future designs of their virtual storefronts for different future dates, and to modify these designs interactively while being informed of product window information for various products. Accordingly, in an embodiment, a storefront design screen and a resource palette are provided that are keyed to a design for a particular future date. Sellers can dynamically modify their virtual storefronts for a particular future date based on product window information for a set of media assets, and to save the instance of the virtual storefront for later deployment (e.g., uploading to web hosting service provider).

In some instances, sellers (or web designers acting on behalf of the sellers) may wish to see how their virtual storefronts will look on some future date, or how their virtual storefronts looked on some past date. This would allow sellers, for example, to better plan promotions for products, and to determine whether or not displaying certain product listings is likely to be advantageous or not. In accordance with an embodiment of the present invention, sellers are provided with “look-ahead” capability that enables a seller to view a virtual storefront as it would appear on a specified date in the future. The look-ahead feature may generate the future virtual storefront from layout data that defines the formatting of the storefront webpages and product listings for media assets having product windows that overlap with the future date. In accordance with another embodiment of the present invention, sellers are provided with “look-back” capability that enables a seller to view a virtual storefront as it appeared on a specified date in the past. The look-back feature may generate the past virtual storefront from layout data that defines the formatting of the storefront webpages and product listings for media assets having product windows that overlap with the past date.

The amount of potential products that may be promoted by a seller on any given date may be substantial. Consequently, many sellers desire an administrative tool through an interface that allows sellers to efficiently navigate content selections and easily identify content that they may desire to promote. An application that provides such guidance is referred to herein as an interactive e-commerce application or, sometimes, a storefront application or a storefront administration application.

Storefront administration applications may take various forms depending on the content for which they provide guidance. Storefront administration applications may generate graphical user interface screens that enable a seller to navigate, edit, arrange, sort, and access additional information about products sold or promoted on a webpage. In addition, a storefront administration application may be incorporated or communicate with a web design application (e.g., Adobe Dreamweaver) to modify webpages administered by the seller. One type of product may be media assets or media content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. The storefront administration applications may be provided as on-line applications (i.e., provided on a website), or as stand-alone applications or clients on user equipment devices. Various devices and platforms that may implement storefront administration applications are described in more detail below.

Users may access the storefront administration application (and its display screens described above and below) from one or more of their user equipment devices. FIG. 1A shows a generalized embodiment of illustrative user equipment device 100. More specific implementations of user equipment devices are discussed below in connection with FIG. 1B. User equipment device 100 may receive data via input/output (hereinafter “I/O”) path 102. I/O path 102 may provide data used for the function of the storefront administration application (e.g., data related to virtual storefronts, data related to products, Internet content, content available over a local area network (LAN) or wide area network (WAN), and/or other content) to control circuitry 104, which includes processing circuitry 106 and storage 108. Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1A to avoid overcomplicating the drawing.

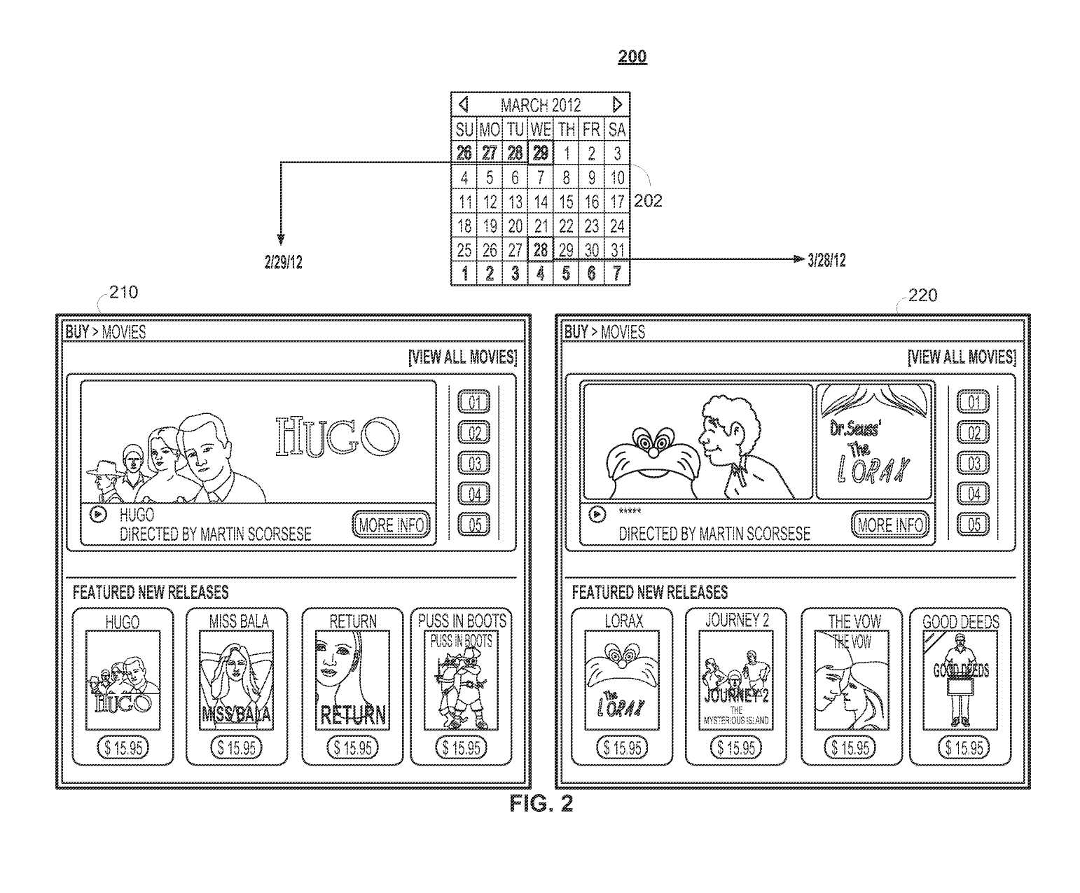

Control circuitry 104 may be based on any suitable processing circuitry such as processing circuitry 106. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 104 executes instructions for a storefront administration application stored in memory (i.e., storage 108). Specifically, control circuitry 104 may be instructed by the storefront administration application to perform the functions discussed above and below. For example, the storefront administration application may provide instructions to control circuitry 104 to generate the application displays (e.g., as shown in FIGS. 2-7 below). In some implementations, any action performed by control circuitry 104 may be based on instructions received from the storefront administration application.

In client-server based embodiments, control circuitry 104 may include communications circuitry suitable for communicating with a storefront administration application server or other networks or servers. The instructions for carrying out the above-mentioned functionality may be stored on a remote server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 1B). In addition, communications circuitry may include circuitry that enables peer-to-peer communication of user equipment devices, or communication of user equipment devices in locations remote from each other (described in more detail below).

Memory may be an electronic storage device provided as storage 108 that is part of control circuitry 104. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 108 may be used to store various types of content described herein. Nonvolatile memory may also be used (e.g., to launch a boot-up routine and other instructions). Cloud-based storage, described in relation to FIG. 1B, may be used to supplement storage 108 or instead of storage 108.

Control circuitry 104 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 104 may also include scaler circuitry for upconverting and downconverting content into the preferred output format of the user equipment 100. Circuitry 104 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 108 is provided as a separate device from user equipment 100, the tuning and encoding circuitry (including multiple tuners) may be associated with storage 108.

A user may send instructions to control circuitry 104 using user input interface 110. User input interface 110 may be any suitable user interface, such as a remote control, mouse, trackball, keypad, keyboard, touch screen, touchpad, stylus input, joystick, voice recognition interface, or other user input interfaces. Display 112 may be provided as a stand-alone device or integrated with other elements of user equipment device 100. Display 112 may be one or more of a monitor, a television, a liquid crystal display (LCD) for a mobile device, or any other suitable equipment for displaying visual images. In some embodiments, display 112 may be HDTV-capable. In some embodiments, display 112 may be a 3D display, and the interactive storefront administration application and any suitable content may be displayed in 3D. A video card or graphics card may generate the output to the display 112. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 104. The video card may be integrated with the control circuitry 104. Speakers 114 may be provided as integrated with other elements of user equipment device 100 or may be stand-alone units. The audio component of videos and other content displayed on display 112 may be played through speakers 114. In some embodiments, the audio may be distributed to a receiver (not shown), which processes and outputs the audio via speakers 114.

The storefront administration application may be implemented using any suitable architecture. For example, it may be a stand-alone application wholly implemented on user equipment device 100. In such an approach, instructions of the application are stored locally, and data for use by the application is downloaded on a periodic basis (e.g., from an out-of-band feed, from an Internet resource, or using another suitable approach). In some embodiments, the storefront administration application is a client-server based application. Data for use by a thick or thin client implemented on user equipment device 100 is retrieved on-demand by issuing requests to a server (e.g., remote server 152 (FIG. 1B) remote to the user equipment device 100. In one example of a client-server based storefront administration application, control circuitry 104 runs a web browser that interprets web pages provided by a remote server.

In some embodiments, the storefront administration application is downloaded and interpreted or otherwise run by an interpreter or virtual machine (run by control circuitry 104). In some embodiments, the storefront administration application may be encoded in the ETV Binary Interchange Format (EBIF), received by control circuitry 104 as part of a suitable feed, and interpreted by a user agent running on control circuitry 104. For example, the storefront administration application may be an EBIF application. In some embodiments, the storefront administration application may be defined by a series of JAVA-based files that are received and run by a local virtual machine or other suitable middleware executed by control circuitry 104. In some of such embodiments (e.g., those employing MPEG-2 or other digital media encoding schemes), the storefront administration application may be, for example, encoded and transmitted in an MPEG-2 object carousel with the MPEG audio and video packets of a program.

User equipment device 100 of FIG. 1A can be implemented in system 150 of FIG. 1B as user television equipment, user computer equipment, wireless user communications devices, or any other type of user equipment suitable for accessing content, such as a non-portable gaming machine. For simplicity, these devices may be referred to herein collectively as user equipment or user equipment devices. User equipment devices, on which a storefront administration application may be implemented, may function as a standalone device or may be part of a network of devices. Various network configurations of devices may be implemented and are discussed in more detail below.

In system 150, there is typically more than one of each type of user equipment device but only one of each is shown in FIG. 1B to avoid overcomplicating the drawing. In addition, each user may utilize more than one type of user equipment device and also more than one of each type of user equipment device. The user equipment 100 may be coupled to communications network 156. Communications network 156 may be one or more networks including the Internet, a mobile phone network, mobile voice or data network (e.g., a 4G or LTE network), cable network, public switched telephone network, or other types of communications network or combinations of communications networks. Paths 158, 160, and 162 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Communications between devices in FIG. 1B may be provided by one or more of these communications paths, but are shown as a single path in FIG. 1B to avoid overcomplicating the drawing.

In addition, devices may communicate directly with each other via communication paths, such as those described above in connection with paths 158, 160, and 162, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC.

System 150 includes remote server 152 and remote data source 154 coupled to communications network 156 via communication paths 160 and 162, respectively. Communications with the remote server 152 and remote data source 154 may be exchanged over one or more communications paths, but are shown as a single path in FIG. 1B to avoid overcomplicating the drawing. In addition, there may be more than one of each of remote server 152 and remote data source 154, but only one of each is shown in FIG. 1B to avoid overcomplicating the drawing. If desired, remote server 152 and remote data source 154 may be integrated as one device.

Content source 416 may include one or more types of data distribution equipment. Content source 416 may also include a remote media server used to store different types of data, in a location remote from any of the user equipment devices. Systems and methods for remote storage of data, and providing remotely stored content to user equipment are discussed in greater detail in connection with Ellis et al., U.S. Pat. No. 7,761,892, issued Jul. 20, 2010, which is hereby incorporated by reference herein in its entirety.

Remote data source 154 may provide data related to virtual storefronts or products, including products listings. Storefront administration application data may be provided to the user equipment devices using any suitable approach. In some embodiments, the storefront administration application may be a stand-alone application that receives data via a data feed (e.g., a continuous feed or trickle feed).

In some embodiments, data from remote data source 154 may be provided to users' equipment using a client-server approach. For example, a user equipment device may pull data from a server, or a server may push data to a user equipment device. In some embodiments, a storefront administration application client residing on the user's equipment may initiate sessions with remote data source 154 to obtain data when needed, e.g., when the data is out of date or when the user equipment device receives a request from the user to receive data. Data may be provided to the user equipment with any suitable frequency (e.g., continuously, daily, a user-specified period of time, a system-specified period of time, in response to a request from user equipment, etc.). Remote data source 154 may provide user equipment 100 devices the storefront administration application itself or software updates for the storefront administration application.

Storefront administration applications may be, for example, stand-alone applications implemented on user equipment devices. For example, the storefront administration application may be implemented as software or a set of executable instructions which may be stored in storage 108, and executed by control circuitry 104 of a user equipment device 100. In some embodiments, storefront administration applications may be client-server applications where only a client application resides on the user equipment device, and server application resides on a remote server. For example, storefront administration applications may be implemented partially as a client application on control circuitry 104 of user equipment device 3100 and partially on a remote server as a server application (e.g., remote server 152) running on control circuitry of the remote server. When executed by control circuitry of the remote server, the storefront administration application may instruct the control circuitry to generate the storefront administration application displays and transmit the generated displays to the user equipment devices. The server application may instruct the control circuitry of the remote server 152 to transmit data for storage on the user equipment. The client application may instruct control circuitry of the receiving user equipment to generate the storefront administration application displays.

Data delivered to user equipment 100 may be over-the-top (OTT) content. OTT content delivery allows Internet-enabled user devices, including any user equipment device described above, to receive data that is transferred over the Internet, including any data described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide data related to the virtual storefront and/or products described above. In addition to content and/or other data, providers of OTT data can distribute storefront administration applications (e.g., web-based applications or cloud-based applications), or the data can be displayed by storefront administration applications stored on the user equipment device.

System 150 is intended to illustrate a number of approaches, or network configurations, by which user equipment devices and sources of content and other data may communicate with each other for the purpose of accessing content and providing the application to a user. The embodiments described herein may be applied in any one or a subset of these approaches, or in a system employing other approaches for delivering content and providing the application to a user. The following four approaches provide specific illustrations of the generalized example of FIG. 1B.

In one approach, user equipment devices may communicate with each other within a home network. User equipment devices can communicate with each other directly via short-range point-to-point communication schemes described above, via indirect paths through a hub or other similar device provided on a home network, or via communications network 156. Each of the multiple individuals in a single home may operate different user equipment devices on the home network. As a result, it may be desirable for various data or settings to be communicated between the different user equipment devices. For example, it may be desirable for users to maintain consistent storefront administration application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain data needed to the application. For example, some users may have home networks that are accessed by in-home and mobile devices. Users may control in-home devices via a storefront administration application implemented on a remote device. For example, users may access an online storefront administration application on a website via a personal computer at their office, or a mobile device such as a PDA or web-enabled mobile telephone. The user may set various settings (e.g., recordings, reminders, or other settings) on the online storefront administration application to control the user's in-home equipment. The online guide may control the user's equipment directly, or by communicating with a storefront administration application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their storefront administration application to communicate directly with remote server 152 to access data. Users may also access the storefront administration application outside of the home using wireless user communications devices to navigate among and locate desirable data.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 156. These cloud resources may include one or more remote server 152 and one or more remote data sources 154.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content-sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

Cloud resources may be accessed by a user equipment device using, for example, a web browser, a media storefront administration application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 1A.

Turning to FIG. 2, diagram 200 shows a conceptual illustration of virtual storefront look-ahead and look-back capability in accordance with an embodiment of the present invention. Specifically, screen 210 shows an exemplary virtual storefront as it would appear on Feb. 29, 2012, while screen 220 shows an exemplary storefront as it would appear on Mar. 28, 2012. As depicted, the same storefront may present different product listings for media assets depending on the selected date. It is noted that calendar 202 is depicted to illustrate the differing dates, and is not necessarily a display element. In some embodiments, however, a user may be able to invoke a calendar similar to calendar 202 to select the desired date.

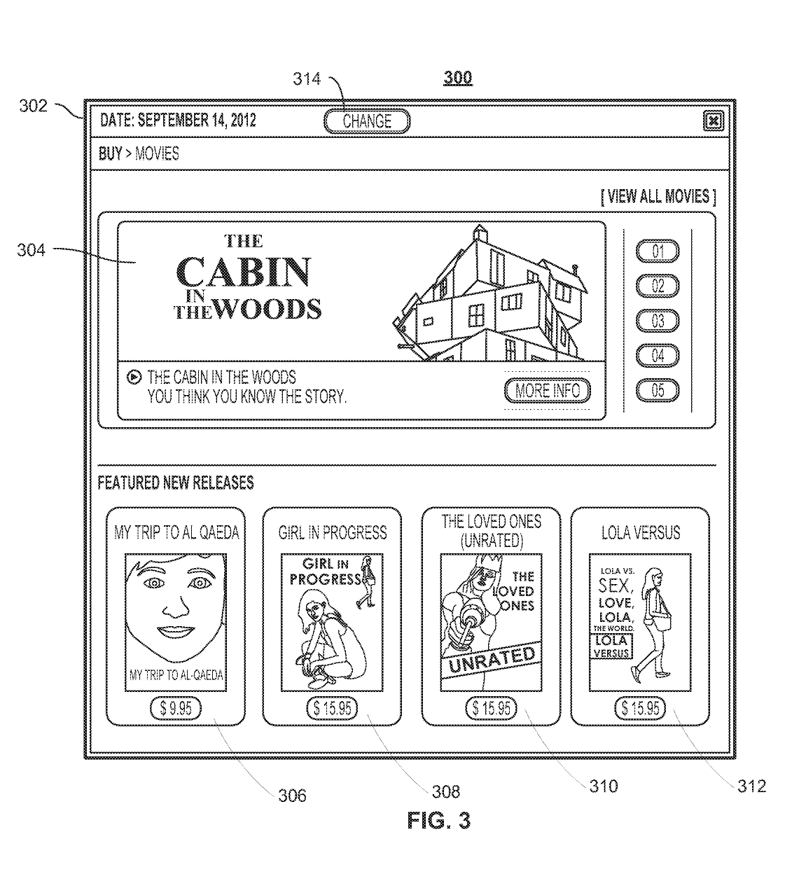

The storefront administration application may generate a display as seen by a customer (e.g., as described in relation to FIG. 2) or as seen by a user (e.g., as described in relation to FIG. 3) from layout information and product listings. By processing data received for the virtual storefront (e.g., as described in relation to FIG. 8A) or the product (e.g., as describe din relation to FIG. 8B), the storefront administration application instruct the control circuitry of the equipment or device (e.g., any of the devices described in FIG. 1A-B) upon which it is implement to generate a display screen according the received data. The layout information may define the formatting of various webpages to be displayed to customers when visiting the storefront's web-site. The layout information may define one or more promotional regions in which product listings are to be displayed. The particular product listings selected for display may depend on the date the virtual storefront is to be deployed to the public. Thus, multiple instances of the virtual storefront may be created and stored, each associated with a different deployment date. The layout information and product listings for the multiple instances of the virtual storefront may be stored even after deployment, thereby providing access to past, as well as future, instances of the virtual storefront.

In FIG. 2, for example, screen 210 may represent the current virtual storefront as it would appear to a customer that accesses the virtual storefront. Screen 220 may represent the virtual storefront as it would appear in the future, e.g., on Mar. 28, 2012. Alternatively, screen 220 may represent the current virtual storefront as it would appear to a customer that accesses the storefront web site, and screen 210 may represent the virtual storefront as it would appear in the past, e.g., on Feb. 29, 2012. By selecting a date, a seller can navigate amongst past, present, and future instances of the virtual storefront, each of which may present different product listings.

In an embodiment, a virtual storefront for a particular date may be generated using layout information, product listings, and a given date. The layout information may define the format of the virtual storefront, including the placement of various display elements and interface controls, and the positioning of one or more promotional regions. A promotional region may be a frame, cell, or any other area of a webpage used to display a product listing. The layout information, as well as product listings for multiple media assets, may be stored in a storage device (e.g., in a database incorporated into user equipment 100, remote server 152, and/or remote data source 154 (FIG. 1B). Each product listing may be associated with a storefront identifier and a date range specifying its availability for purchase (i.e., product window of the product).

In order to generate the virtual storefront, the storefront administration application may process a storefront identifier uniquely associated with the desired storefront to retrieve (e.g., from user equipment 100, remote server 152, and/or remote data source 154 (FIG. 1B)) the layout information, while the storefront identifier and the given date may be processed to retrieve (e.g., from user equipment 100, remote server 152, and/or remote data source 154 (FIG. 1B) one or more product listings to be displayed within the promotional regions defined by the layout information. The storefront administration application may then rendered a webpage based on the layout information and retrieved product listings, with the retrieved product listings displayed within the promotional regions defined by the layout information, thereby producing a virtual storefront.

The storefront identifier may indicate, to the storefront administration application, a unique storefront (e.g., a seller may have a number of storefronts and multiple sellers may each have storefronts, each uniquely identifiable using a storefront identifier), which may be a dataset including layout information, display elements, and/or any other information used to render the storefront as a webpage. The requested storefront identifier and requested date received by the storefront administration application may be default data or may be specifically indicated by a user (e.g., via user input interface 110 (FIG. 1A).

FIG. 3 shows an illustrative display of the storefront administration application used to generate webpages featuring product listings in multiple promotional regions in accordance with some embodiments of the disclosure. It should be noted that a storefront administration application may be implemented on the equipment or devices as shown and described in relation to FIGS. 1A-B may be used to generate the display screen 300. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)) to generate display screen 300.

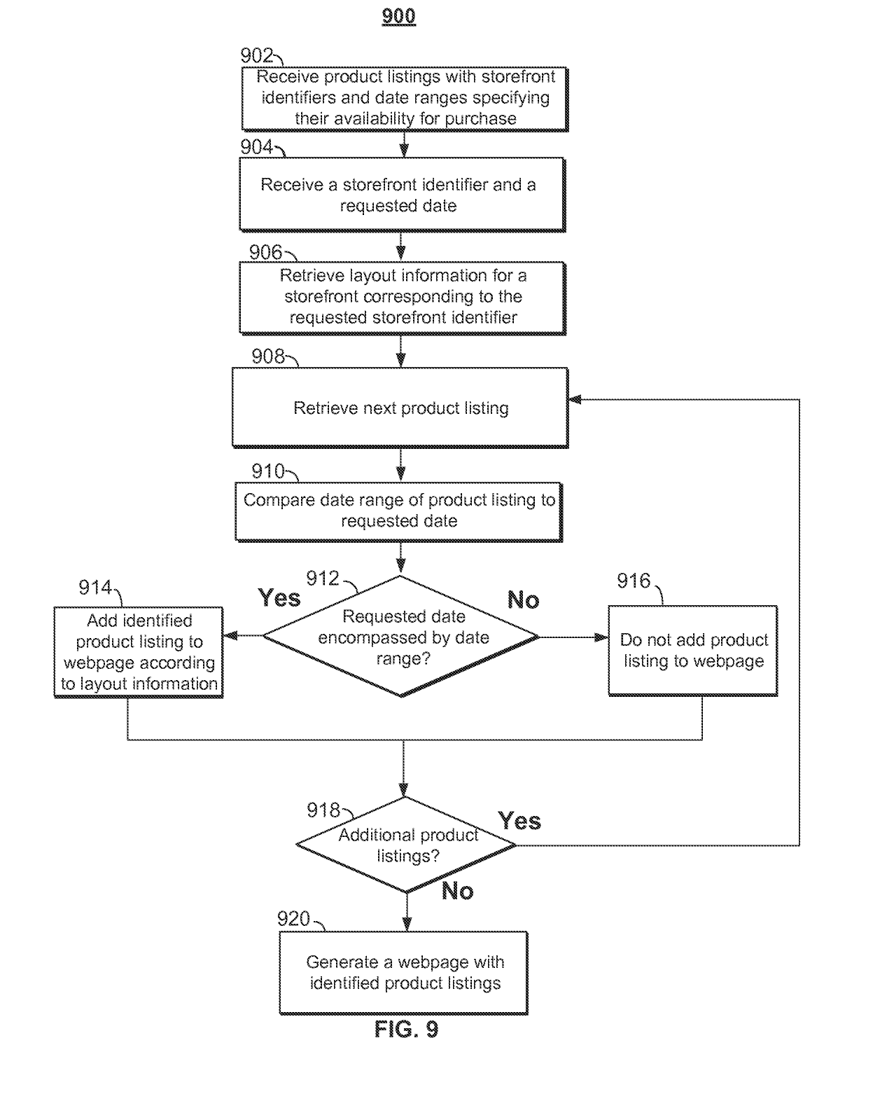

Display screen 300 illustrates a webpage that may be generated by the storefront administration application to provide a seller with the capability to interactively modify their virtual storefronts while being informed of what products are available, unavailable, or will soon become available or unavailable. Display screen 300 includes a date indicator 302, currently displaying the date “Sep. 14, 2012.” The data indicator 302 indicates a requested date, which may be a default date (e.g., the current date) or may be a date specifically indicated by a user (e.g., the seller). In some embodiments, the requested data may be received with the storefront identifier (e.g., in data structure 800 (FIG. 8B). In response to receiving the requested date, the storefront administration application may instruct the control circuitry of the device upon which it is implemented to generate a webpage of the product listings available on the requested date (e.g., as described in relation to FIG. 9 below).

Display screen 300 also includes numerous promotional regions of various sizes. For example, promotional region 304 is larger than promotional regions 306, 308, 310, and 312. Each promotional region and/or the product featured in each promotional region may be selected and modified by a user (e.g., via user input interface 110 (FIG. 1A)). For example, promotion region 304 may include a product the user believes to marketable; therefore, the product is displayed in a larger promotional region (e.g., in order to be more recognizable to a potential customer).

In display screen 300, the storefront administration application has currently populated promotional regions 304, 306, 308, 310, and 312 with a product listing. For example, a product listing in a promotional region may include, but is not limited to, a title, graphic, purchase price, summary, and/or other information that may be valuable to a customer interested in the listed product. Furthermore, the information displayed in each promotional region may be edited by the storefront administration application through a user input (e.g., via user input interface 110 (FIG. 1A).

Display screen 300 also includes change date icon 314. Change date icon 314 allows the user to select a different date (e.g., via user input interface 110 (FIG. 1A)) for which the storefront administration application will generate a webpage showing the available products. For example, a user may wish to view the products that will be available two months into the future, or may wish to see the products that were available two months in the past. In some embodiments, for the selected date, the storefront administration application may have searched a plurality of product listings (e.g., stored on user equipment 100, remote server 152, remote data source 154, and/or any device accessible via communications network 156 (FIG. 1B)) to identify a product listing associated with the requested storefront identifier and a date range that encompasses the date in date indicator 302 and generated display screen 300 using retrieved layout information (e.g., stored on user equipment 100, remote server 152, remote data source 154, and/or any device accessible via communications network 156 (FIG. 1B)).

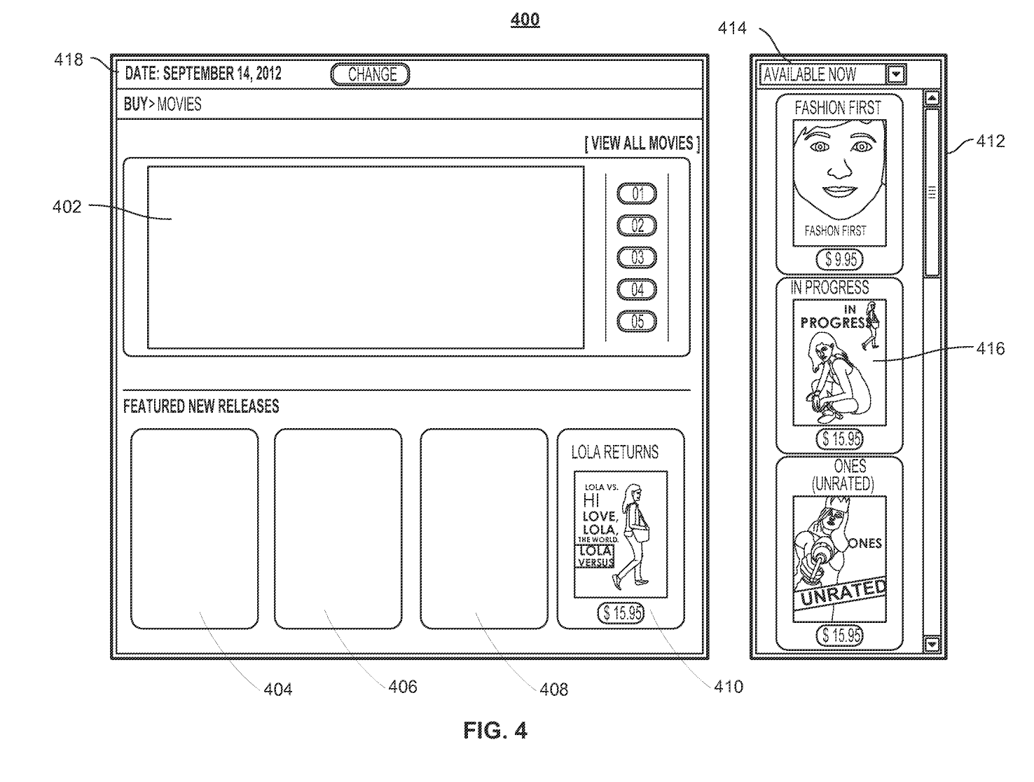

FIG. 4 shows an illustrative display screen of a storefront administration application used to generate a webpage featuring look-ahead and look-back capabilities for a virtual storefront, including a resource palette used to view the availability status of products. It should be noted that a storefront administration application may be implemented on the equipment or devices as shown and described in relation to FIGS. 1A-B may be used to generate the display screen 400. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)) to generate display screen 400.

Display screen 400 includes multiple promotional regions 402, 404, 406, and 408, which do not yet have products populated with them as well as one promotional region 410, which does have a product populated within. For example, display screen 400 may represent a webpage that is currently being modified and/or created by a user. The storefront administration application may In some embodiments, display screen 400 may represent a display screen a user views as the user is modifying (e.g., via user input interface 110 (FIG. 1A)) the products promoted in each promotional region. For example, a user may use resource palette 412 to determine particular products to include in promotional regions 402, 404, 406, and 408.

A user may search product listings using search criteria accessed via search tool 414. The different search criteria may be inputted by a user (e.g., via user input interface 110 (FIG. 1A)). The storefront administration application may receive the user input and instruct the control circuitry of its host device to modify (or re-generate according to the updated criteria) the webpage. For example, search tool 414 currently displays products that are available on Sep. 14, 2012, the date shown in date indicator 418. Resource palette 412 also includes product listing 416, a content listings matching the criteria of search tool 414. In some embodiments, a user may place the product listing 416 (e.g., by dragging and dropping the product listing using user input interface 110 (FIG. 1A)) into promotional region 402, 404, 406, and/or 408.

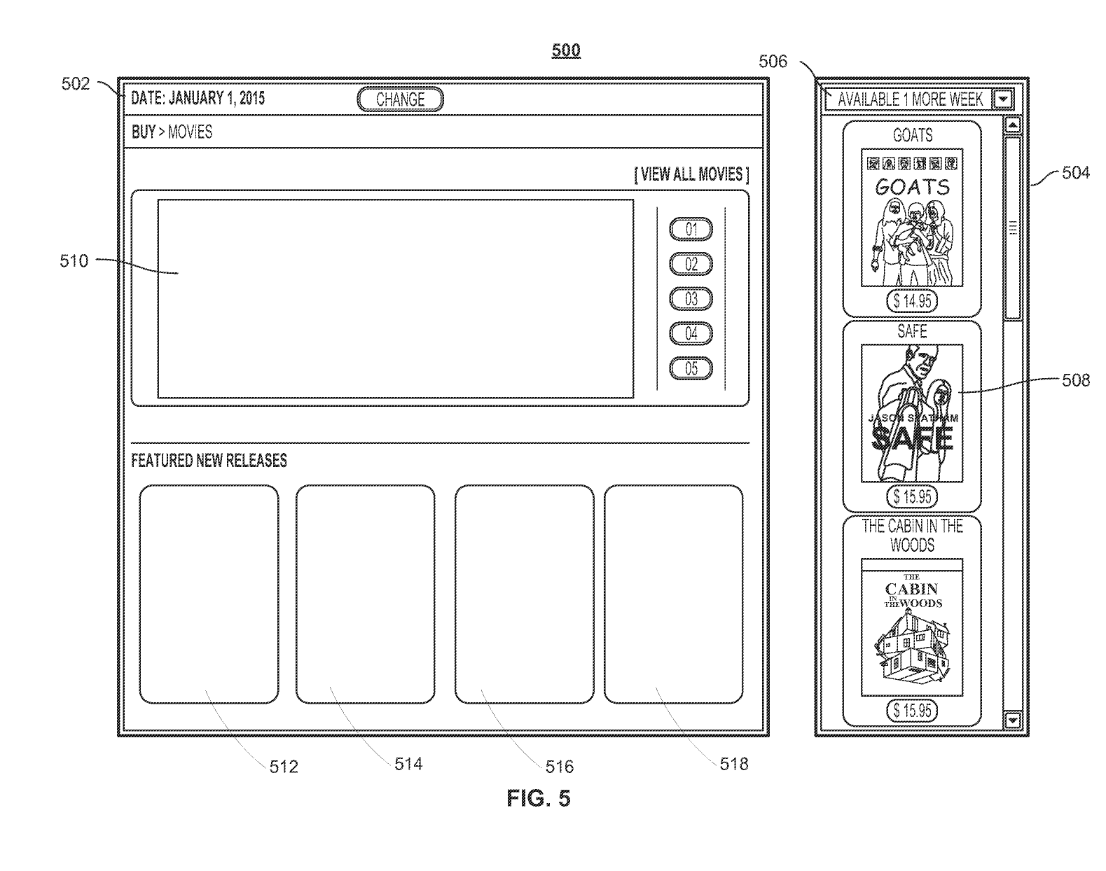

FIG. 5 shows an illustrative display of the storefront administration application used to generate a webpage featuring look-ahead and look-back capabilities for a virtual storefront, including a resource palette used to view the availability status of products. It should be noted that a storefront administration application may be implemented on the equipment or devices as shown and described in relation to FIGS. 1A-B may be used to generate the display screen 500. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)) to generate display screen 500.

Display screen 500 illustrates a display screen generated by the storefront administration application for a particular future date. As indicated by date indicator 502, display screen 500 corresponds to “Jan. 1, 2015.” Promotional regions 510, 512, 514, 516, and 518 are currently empty, indicating that a user has not yet selected product listings (e.g., via user input interface 110 (FIG. 1A)) to include in those promotional regions.

Resource palette 504 indicates product listings (e.g., product listing 508) that may appear in promotional regions 510, 512, 514, 516, and 518. The product listings in resource palette 504 have been selected according to the criteria of search tool 506. In this case, the listings in resource palette 504 are available for one more week after the date indicated by date indicator 502.

In some embodiments, resource palette 504 may indicate a plurality of product listings that are available at the date of date indicator 502. From the plurality of listings, a sub-plurality of listings may be determined via entering search criteria into search tool 506. For example, the product window of product listing 508 may include both the date indicated in date indicator 502 as well as the date range resulting from search criteria entered into search tool 506.

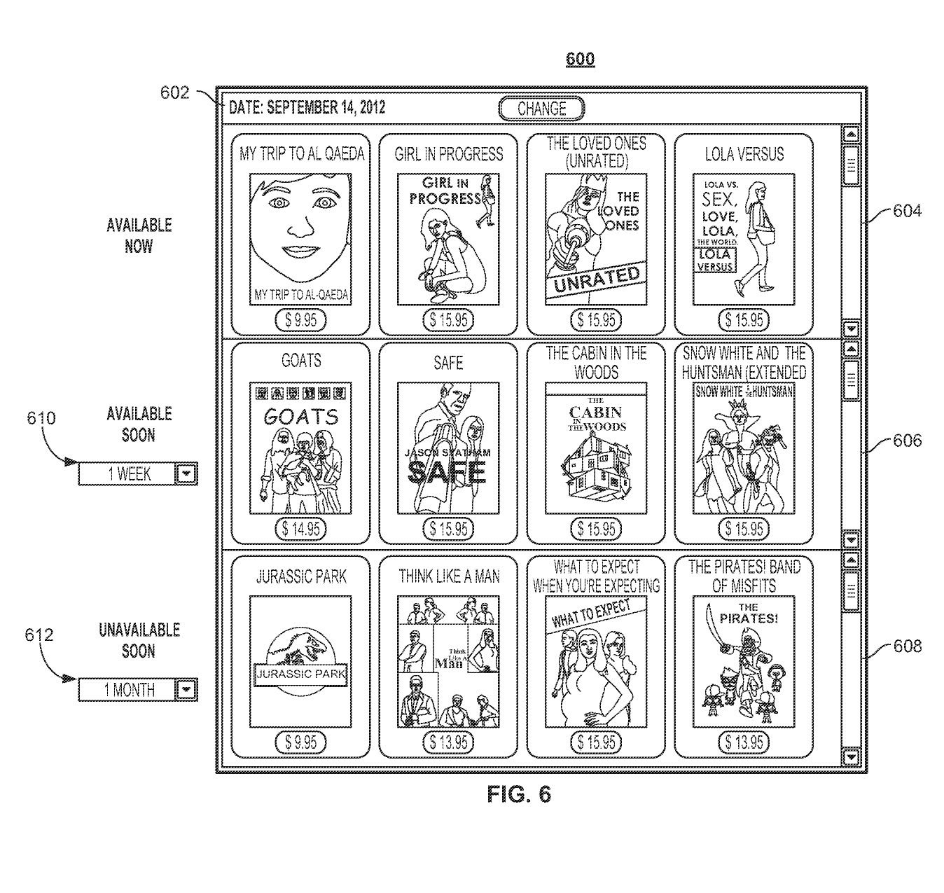

FIG. 6 shows an illustrative display of the storefront administration application used to generate a webpage featuring look-ahead and look-back capabilities for a virtual storefront, including multiple resource palettes used to view the availability status of products. It should be noted that a storefront administration application may be implemented on the equipment or devices as shown and described in relation to FIGS. 1A-B may be used to generate the display screen 600. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)) to generate display screen 600.

Display screen 600 illustrates a display screen generated by the storefront administration application for a particular date as indicated by date indicator 602. In some embodiments, the storefront administration application may generate display screen 600 in response to receiving a user input (e.g., via user input interface 110 (FIG. 1A)). Display screen 600 further includes resource palettes 604, 606, and 608. Resource palette 604 indicates products listings that are available at the date in date indicator 602. Resource palette 606 indicates product listings that are available within one week (e.g., as indicated by search tool 610) of the date in date indicator 602. Resource palette 608 indicates product listings that may become unavailable in one month (e.g., as indicated by search tool 612) of the date in date indicator 602. The product listings in resource palettes 604, 606, and 608 may be used to populate promotional regions (e.g., promotional region 304 (FIG. 3)), or may be used by a user editing a webpage for a virtual storefront.

FIG. 7 shows an illustrative display of the storefront administration application used to view additional information of product listings that may appear in promotional regions of a webpage generated by the storefront administration application. It should be noted that a storefront administration application may be implemented on the equipment or devices as shown and described in relation to FIGS. 1A-B may be used to generate the display screen 700. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)) to generate display screen 700.

Display screen 700 includes a plurality of product listings. In some embodiments, the product listings may correspond to products that are available on a particular date and/or may correspond to product listing display according to particular criteria of a search tool (e.g., search tool 610 (FIG. 6) in a resource palette (e.g., resource palette 606 (FIG. 6)). The product listings in display screen 700 may be scrolled over (e.g., via user input interface 110 (FIG. 1A)) to reveal additional information about the product such as the product window, genre, cast and crew, and/or historical information such as ratings data, popularity data, box office data, and critical reviews.

For example, in display screen 700, product listing 702 has been selected by a user (e.g., via user input interface 110 (FIG. 1A)). In response, the storefront administration application has provided box office ticket sales, critical reviews, and viewer ratings. This information may assist the user in determining whether or not customers will likely be interested in the particular product. In some embodiments, a user may further be able to sort product listings according to any criteria in the additional information. For example, a user may search and retrieve all product listings that grossed a threshold amount of money during a particular time period.

FIG. 8A is an illustrative data structure of data that accompanies a storefront identifier in accordance with some embodiments of the disclosure. Data structure 800 is an illustrative data structure of a storefront identifier. For example, in some embodiments, a storefront identifier may be received by the storefront administration application. For example, the storefront administration application may be implemented on remote server 152 (FIG. 1B), and the user may use user equipment 100 (FIG. 1B) to transmit (e.g., via communications network 156 (FIG. 1B)) instructions (e.g., via user input interface 110 (FIG. 1A)) to the remote server.

Data structure 800 includes line 802, which indicates to the storefront administration application the particular virtual storefront for which the storefront administration application is to generate a webpage featuring look-ahead and look-back capabilities. For example, line 802 indicates a particular alphanumeric code that the storefront administration application may cross-reference with a look-up table to determine the particular virtual storefront with which to associate with the requests.

Line 804 indicates the particular date for which the user would like to generate a webpage. For example, in some embodiments, line 804 may correspond to the date appearing in a date indicator (e.g., date indicator 302 (FIG. 3)) in a display screen of the storefront administration application (e.g., display screen 300 (FIG. 3)).

Line 806 through line 818 indicate the layout information corresponding to the storefront identifier. For example, the layout information includes information regarding the promotions region (e.g., line 808 through line 814) such as the number of promotion regions (e.g., line 810) and the size of each promotions regions (e.g., line 812). In addition, the layout information may include information about the design of the webpage (e.g., line 816).

It should be noted that in some embodiments, the layout information may be stored on a device (e.g., any of the devices shown in FIG. 1 A-B) and may not be received with the storefront identifier. Furthermore, it should be noted that the information included in data structure 800 is meant to be exemplary only and that, in some embodiments, information may be added or removed.

FIG. 8B is an illustrative data structure of data associated with a product listing in accordance with some embodiments of the disclosure. Data structure 850 is an illustrative of data associated with a product listing. For example, in some embodiments, data structure 850 may be received by the storefront administration application. For example, the storefront administration application may be implemented on remote server 152 (FIG. 1B), and the information associated with product listing may be transmitted (e.g., via communications network 156 (FIG. 1B)) to the remote server from remote data source 154 (FIG. 1B). The information in data structure 850 may then be stored until it is retrieve by the storefront administration application (e.g., in response to a user accessing the storefront administration application).

Data structure 850 includes line 852, which identifies the product listing to the storefront administration application. For example, the storefront administration application may enter line 852 into a look-up table database (e.g., on any of the devices in FIG. 1A-B) to determine the particular product with which to associate data structure 850.

Line 854 indicates the product window of the product associated with data structure 850. For example, the storefront administration application may determine whether or not the date received in a storefront identifier (e.g., as described in FIG. 8A) is included within the dates included in line 854. If the date is included in the product window, the product listing associated with data structure 850 may be displayed on a display screen e.g., display screen 300 (FIG. 3) of the storefront administration application.

Line 856 indicates to the storefront administration application the particular virtual storefront on which the product listing associated with data structure 850 may be displayed. For example, in some embodiments, the storefront administration application may store the product listings that will appear on a particular virtual storefront at any time in a database. Upon receiving an indication of a requested storefront identifier, the storefront administration application may reference the database of product listings for that particular storefront identifier. The storefront administration application may then search the database for product listings with a product window that encompasses the requested date. Product listings with a date range encompassed by the requested date may be produced on a display screen (e.g., display screen 300 (FIG. 3)). In some embodiments, data structure 850 may include numerous storefront identifiers, corresponding to every virtual storefront on which the product may be available.

Lines 858 through 860 indicate additional information about a product listing that may be included in a database of information regarding the product listing or that may be displayed in a promotional region (e.g., promotional region 304 (FIG. 3)). For example, line 858 indicates a price associated with the product listing. Line 860 indicates a title of the product.

It should be noted that, in some embodiments, the layout information may be store on a device (e.g., any of the devices shown in FIG. 1 A-B) and may not be received with the storefront identifier. Furthermore, it should be noted that the information included in data structure 800 is meant to be exemplary only and that, in some embodiments, information may be added or removed. For example, in some embodiments, data structure 850 may include a summary of the product or may include a graphic that is to be displayed in a promotional region associated with the product. Additionally and/or alternatively, data structure 850 may include any tags, indicators, code, or signals identifying any additional information as discussed above.

FIG. 9 is a flowchart of illustrative steps for generating a webpage for a particular date featuring product listings identified as available on that date. FIG. 9 describes process 900. Process 900 describes a method for generating a webpage with product listings identified as being available on a requested date.

It should be noted that the equipment or devices as shown and described in relation to FIGS. 1A-B may be used to perform any step in process 900. For example, in some embodiments, the storefront administration application may be located on user equipment 100, remote server 152, remote data source 154, and/or any device accessible via communications network 156 (FIG. 1B), and the storefront administration application may instruct the equipment or devices using processing circuitry (e.g., processing circuitry 106 (FIG. 1A)). Furthermore, it is contemplated that the steps or descriptions of FIG. 9 may be used with any other embodiment of this disclosure. In addition, the steps and descriptions described in relation to FIG. 9 may be done in alternative orders or in parallel to further the purposes of this disclosure. For example, each of these steps may be performed in any order or in parallel or substantially simultaneously to reduce lag or increase the speed of the system or method.

At step 902, the storefront administration application receives product listings with storefront identifiers and date ranges specifying their availability for purchase. For example, storefront administration application may receive a data structure (e.g., data structure 850 (FIG. 8B)), which indicates a particular product window (e.g., line 854) for the product associated with the product listings. In some embodiments, the product listing may be stored on a local (e.g., storage 108 (FIG. 1A)) or remote (e.g., remote server 152 (FIG. 1B)). In some embodiments, the product listings information may be received from remote data source 154 (FIG. 1B). For example, the product listings may be received from a third party or other information source.

At step, 904, the storefront administration application receives a storefront identifier and a requested date. For example, the storefront administration application may receive an indication of a requested storefront identifier (e.g., line 802 (FIG. 8A)) and a requested date (e.g., line 804 (FIG. 8A)) in response to a user input (e.g., via user input interface 110 (FIG. 1A)). In some embodiments, the requested date may correspond to the date in a date indicator (e.g. date indicator 302 (FIG. 3)) in a display screen (e.g., display screen 300 (FIG. 3)).

At step 906, the storefront administration application retrieves layout information for a storefront corresponding to the requested storefront identifier. For example, the storefront administration application may receive data (e.g., lines 806 through 818 (FIG. 8A)) describing the number, size, and positioning of promotional regions (e.g., promotional region 304 (FIG. 3)) in a display screen. In addition, the data may describe other attributes regarding the webpage, for example the colors, text font, etc. (e.g., as indicted in line 816 (FIG. 8A)).

At step 908, the storefront administration application retrieves the next product listing associated with the storefront identifier. If process 900 is in its first iteration, the next product listing may also be the first product listing associated with the storefront identifier. For example, in some embodiments, product listings associated with a particular storefront (e.g., via a storefront identifier embedded with data associated with a product listing). The product listings associated with each virtual storefront may be stored in a database until retrieved (e.g., in response to a user input via user input interface 110 (FIG. 1A)). For example, in some embodiments, the storefront administration application may search a plurality of product listings to identify a product listing associated with the requested storefront identifier and a date range that encompasses the requested date. To do so, the storefront administration application may retrieve all product listings associated with the received storefront identifier.

At step 910, the storefront administration application may compare the date range, which may correspond to the product window, of the product listing to the requested date. For example, by comparing the date range as indicated by data associated with the product listing (e.g., line 854 (FIG. 8B)), the storefront administration application may determine whether or not a particular product is available on the requested date. At step 912, the storefront administration application determines whether or not the requested date is encompassed by the date range. For example, the storefront administration application may determine whether or not a requested date (e.g., Sep. 14, 2012 as shown by date indicator 302 (FIG. 3) is encompassed by the date range of a product listing (e.g., Sep. 1, 2012 to Sep. 31, 2012 as indicated by line 854 (FIG. 8B)).

If the requested date is encompassed by the date range, the storefront administration application adds the identified product listing to the webpage according to the layout information. For example, if the layout information indicates that the product listing should be shown in a particular promotional region (e.g., promotional region 304 (FIG. 3)), the storefront administration application with populate that promotional region with the identified product listing. If the requested date is not encompassed by the date range, the storefront administration application does not add the identified product listing to the webpage according to the layout information.

At step 918, the storefront administration application determines whether or not there are additional product listings for the visual storefront associated with the storefront identifier. If so, the storefront administration application returns to step 918. If not the storefront administration application generates a webpage at step 920 using the identified product listings in the particular promotional regions as determined by the layout information.

It should be noted that in some embodiments, additional iterations may be performed on a product listing. For example, in some embodiments, the storefront administration application may further sort or filter available product listings by additional criteria (e.g., as discussed above in relation to resource palettes). In such cases, subsequent iteration on the product listing may be performed in which the requested date is modified to include the search criteria. For example, if the search criteria includes product listing available for only one more week (e.g., as discussed in relation to FIG. 5), the storefront administration application may search for product listings with date ranges ending within a week of the requested date.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted that the systems and/or methods described above may be applied to, or used in accordance with, other systems and/or methods.

1. A method for enabling a user to design a web-based storefront, the method comprising:
storing, in a storage device, a plurality of product listings for media assets, each product listing being associated with a storefront identifier and a date range specifying its availability for purchase;
receiving an indication of a requested storefront identifier and a requested date;
retrieving, from the storage device, layout information for a storefront corresponding to the requested storefront identifier, wherein the layout information defines a promotional region;
searching the plurality of product listings to identify a product listing associated with the requested storefront identifier and a date range that encompasses the requested date; and
generating a webpage using the retrieved layout information, wherein the identified product listing is positioned for display at the promotional region.

2. The method of claim 1, wherein the product listing is a first product listing, the method further comprising:
receiving a user-input of a date different than the requested date;
searching the plurality of product listings to identify a second product listing associated with the requested storefront identifier and a date range that encompasses the user-inputted date; and
regenerating the webpage with the identified second product listing positioned for display at the promotional region.

3. The method of claim 2, wherein the user-inputted date is one of a past date, a current date, and a future date.

4. The method of claim 1, wherein the layout information defines a plurality of promotional regions, the method further comprising:
searching the plurality of product listings to identify a first sub-plurality of product listings each associated with the requested storefront identifier and a date range that encompasses the requested date; and
positioning each of the first sub-plurality of product listings at a respective one of the plurality of promotional regions.

5. The method of claim 4 further comprising:
searching the plurality of product listings to identify a second sub-plurality of product listings each associated with the requested storefront identifier and a date range that at least partially overlaps with a selected date criterion;
generating, for display, a resource palette comprising the second sub-plurality of product listings;
receiving, via user interaction with the resource palette, a user indication to insert a selected one of the second sub-plurality of product listings in a designated one of the plurality of promotional regions; and
updating the webpage with the selected product listing positioned for display at the designated promotional region.

6. The method of claim 5 further comprising:
receiving a user input of a date criterion different than the selected date criterion;
searching the plurality of product listings to identify a third sub-plurality of product listings each associated with the requested storefront identifier and a date range that at least partially overlaps with the user-inputted date criterion; and
updating the resource palette to display the third sub-plurality of product listings.

7. The method of claim 6, wherein the user-inputted date criterion is one of a past date, current date, and future date.

8. The method of claim 6, wherein the user-inputted date criterion is a user-defined date range.

9. The method of claim 5 further comprising:
receiving a user selection of a product listing displayed in the resource palette; and
displaying historical information for the media asset corresponding to the selected product listing.

10. The method of claim 9 further comprising:
in response to receiving the user selection of the product listing displayed in the resource palette, connecting to a server having the historical information, wherein the historical information is at least one of ratings data, popularity data, box office data, and critical reviews; and
retrieving at least a portion of the historical information from the server.

11. A system for enabling a user to design a web-based storefront, the system comprising:
control circuitry configured to:
store, in a storage device, a plurality of product listings for media assets, each product listing being associated with a storefront identifier and a date range specifying its availability for purchase;
receive an indication of a requested storefront identifier and a requested date;
retrieve, from the storage device, layout information for a storefront corresponding to the requested storefront identifier, wherein the layout information defines a promotional region;
search the plurality of product listings to identify a product listing associated with the requested storefront identifier and a date range that encompasses the requested date; and
generate a webpage using the retrieved layout information, wherein the identified product listing is positioned for display at the promotional region.

12. The system of claim 11, wherein the product listing is a first product listing, and wherein the control circuitry is further configured to:
receive a user-input of a date different than the requested date;
search the plurality of product listings to identify a second product listing associated with the requested storefront identifier and a date range that encompasses the user-inputted date; and
regenerate the webpage with the identified second product listing positioned for display at the promotional region.

13. The system of claim 12, wherein the user-inputted date is one of a past date, a current date, and a future date.

14. The system of claim 11, wherein the layout information defines a plurality of promotional regions, and wherein the control circuitry is further configured to:
search the plurality of product listings to identify a first sub-plurality of product listings each associated with the requested storefront identifier and a date range that encompasses the requested date; and
position each of the first sub-plurality of product listings at a respective one of the plurality of promotional regions.

15. The system of claim 14, wherein the control circuitry is further configured to:
search the plurality of product listings to identify a second sub-plurality of product listings each associated with the requested storefront identifier and a date range that at least partially overlaps with a selected date criterion;
generate, for display, a resource palette comprising the second sub-plurality of product listings;
receive, via user interaction with the resource palette, a user indication to insert a selected one of the second sub-plurality of product listings in a designated one of the plurality of promotional regions; and
update the webpage with the selected product listing positioned for display at the designated promotional region.

16. The system of claim 15, wherein the control circuitry is further configured to:
receive a user input of a date criterion different than the selected date criterion;
search the plurality of product listings to identify a third sub-plurality of product listings each associated with the requested storefront identifier and a date range that at least partially overlaps with the user-inputted date criterion; and
update the resource palette to display the third sub-plurality of product listings.

17. The system of claim 16, wherein the user-inputted date criterion is one of a past date, current date, and future date.

18. The system of claim 16, wherein the user-inputted date criterion is a user-defined date range.

19. The system of claim 15, wherein the control circuitry is further configured to:
receive a user selection of a product listing displayed in the resource palette; and
display historical information for the media asset corresponding to the selected product listing.

20. The system of claim 19, wherein the control circuitry is further configured to:
in response to receiving the user selection of the product listing displayed in the resource palette, connect to a server having the historical information, wherein the historical information is at least one of ratings data, popularity data, box office data, and critical reviews; and
retrieve at least a portion of the historical information from the server.

21-30. (canceled)
